(19) United States
(12) Patent Application Publication
(10) Pub. No.: US 2016/0230383 A1
(43) Pub. Date: Aug. 11, 2016

(54) SILICIC ACID MIXTURES AND USE THEREOF AS INSULATION MATERIAL

(71) Applicant: WACKER CHEMIE AG, München (DE)

(72) Inventors: Wolfgang KNIES, Burghausen (DE); Hans EIBLMEIER, Wurmannsquick (DE)

(21) Appl. No.: 15/022,496

(22) PCT Filed: Aug. 27, 2014
(86) PCT No.: PCT/EP2014/068129

§ 371 Date: Mar. 16, 2016

(30) Foreign Application Priority Data
Sep. 18, 2013 (DE) 10 2013 218 689.4

(51) Int. Cl. E04B 1/80; C04B 30/02; C04B 30/00

(52) U.S. Cl. CPC E04B 1/803; C04B 30/00; C04B 30/02

(57) ABSTRACT

Highly efficient thermal insulation is produced at low cost by blending pyrogenic silica with a silicon-containing ash, the mixture thus produced containing no perlite. The pyrogenic silica has a synergistic effect in lowering thermal conductivity.

### CROSS REFERENCE TO RELATED APPLICATIONS

This application is the U.S. National Phase of PCT Appln. No. PCT/EP2014/068129 filed Aug. 27, 2014, which claims priority to German Application No. 10 2013 218 689.4 filed Sep. 18, 2013, the disclosures of which are incorporated in their entirety by reference herein.

### BACKGROUND OF THE INVENTION

1. Field of the Invention

The invention provides a mixture of silica and more than 50% by weight of silicon-containing ash which does not contain any perlite, a process for producing insulation material by producing the mixture according to the invention and introducing the mixture into an envelope, with no sintering occurring in the process. The invention further provides for the use of the thermal insulation material of the invention, especially in the insulation of buildings.

2. Description of the Related Art

Thermal insulation (also referred to as heat insulation) is an important aspect for reducing energy consumption. Thermal insulation is intended to reduce the passage of heat energy through an envelope in order to protect a region against either cooling or heating. Thermal insulation is therefore used to minimize the heating requirement of buildings, to make technical processes possible or reduce the energy consumption thereof, and also in the transport of heat-sensitive goods, e.g. biological or medical products. While, for example, the insulation of refrigerators or hotplates is very well known, the thermal insulation of buildings has become increasingly important in recent times.

Depending on the use temperature, the thermal insulation material (also referred to as “insulation material”) has to meet different requirements. This is because the known heat transfer mechanisms, i.e. transfer by (1) gas conduction, (2) solid state conduction and/or (3) radiation, change with temperature. At ambient temperature, the convection of air, for example, is of greater importance than the radiative conductivity (3), but the influence of the latter increases greatly at higher temperatures or in the case of vacuum systems. Thermal insulation materials have to take this circumstance into account. Since transfer by means of gases (1) is of lesser importance at high temperatures, the pore structure also becomes less important. In the case of shaped bodies which are to be used at high temperatures, the mechanical strength of the thermal insulation body also gains importance, which is why corresponding thermal insulation materials usually contain further constituents, e.g. binders or hardeners. Such constituents would lead to drastic impairment of the thermal insulation at room temperature.

Various materials are used for thermal insulation. One of these is mixtures of microporous powders which, in admixture with additives, either are pressed directly as shaped bodies in the high-temperature insulation or play a role as vacuum insulation panels in thermal insulation at ambient temperature.

A series of mixtures based on microporous inorganic oxides such as silica, in particular pyrogenic silica, which are used as thermal insulation are known in the prior art (see, for example, U.S. Pat. No. 5,911,903). These have the disadvantage that chemically prepared silica, e.g. pyrogenic silica, is relatively expensive and the total costs of the thermal insulation material are therefore very high.

It is known from DE 199 54 474 that a mixture based on dried sea grass which has been cleaned of foreign substances and freed of dust can be used for thermal insulation since this has a high boron content and silica content. No further chemically prepared silica is added to this mixture.

Both in order to reduce the high costs of thermal insulation mixtures and insulation materials arising from the use of chemically prepared silica and also to utilize the good insulation properties of biogenic material, more advantageous silicon dioxide-containing components which are obtained as by-products or waste products are added to the mixtures and shaped bodies based on silica, in particular pyrogenic silica, for use in thermal insulation and the proportion of chemically prepared silica, in particular pyrogenic silica, is kept as low as possible.

For example, DE 43 20 506 provides a shaped body having a layer of burnt, biogenic material which is joined to a layer of pyrogenic silica for insulation in, in particular, the night power storage sector or for a variety of electrical appliances, e.g. kitchen stoves and refrigerators. The total body contains not only pyrogenic silica but also cheap rice hull ash and inorganic hardeners. The use of hardeners has the disadvantage that they have an adverse effect on the thermal insulation properties of a mixture or a shaped body.

DE 10 2006 045 451 discloses thermal insulation material in which part of the pyrogenic silica is replaced by cheaper biological material. The proportion of biogenic or biological material, which has been burnt and possibly pretreated and/or after-treated, is not more than 50% by weight. The thermal insulation material is intended for radiative heating bodies and should therefore satisfy particular purity requirements.

DE 30 20 681, too, discloses a mixture of silica and biogenic material for high-temperature thermal insulation, especially for the insulation, protection or treatment of metal baths during processing or transport thereof, where this is additionally admixed with organic binder in the form of a cellulose-based slurry. However, the addition of binders has the disadvantage that it increases the thermal conductivity of the resulting thermal insulation mixture and thus results in a deterioration in the thermal insulation properties.

In addition, DE 2847807 admixes the thermal insulation mixture with perlite. DE 93 02 904, too, claims a thermal insulation mixture containing perlite according to the invention. The addition of perlite has the disadvantage that the thermal insulation properties and the mechanical stability are decreased.

There is therefore a need to go over from thermal insulation systems based solely on chemically prepared silica to mixtures containing cheaper constituents. If, for example, thermal insulation materials based on pyrogenic silica, which contain hollow glass spheres from 3M (Scotchlite), e.g. the K, S or iM series, are examined, a linear increase in the thermal conductivity with increasing amount of hollow glass spheres accompanied by a decreasing amount of pyrogenic silica is found. The thermal insulation properties thus become poorer, the smaller the proportion of costly pyrogenic silica and the greater the proportion of cheaper silicon-containing constituents.

### SUMMARY OF THE INVENTION

The present invention therefore provides an inexpensive mixture based on silica which can be used for thermal insulation without the thermal insulation properties being significantly impaired, where the mixture contains a very small amount of chemically prepared silica and a proportion of at least 50% by weight of silicon-containing by-products or waste products, but no perlite. It has surprisingly been found that when silicon-containing ashes are used in a mixture based on chemically prepared silica, a significantly lower thermal conductivity than would have been expected in the case of a linear dependence of the thermal conductivity on the percentage of the additive in the mixture is obtained. This is particularly surprising when a high proportion of silicon-containing ashes is added.

### DETAILED DESCRIPTION OF THE PREFERRED EMBODIMENTS

A significant advantage of the mixture of the invention is therefore that it is inexpensive and at the same time has very good thermal insulation properties. It is particularly advantageous that the thermal insulation properties of the mixture of the invention are only slightly poorer than those of a mixture of pure silica without the addition of silicon-containing ashes while being significantly better than those of mixtures which consist only of silicon-containing ashes.

It has been found that it is possible to use more than 50% by weight of silicon-containing ashes in the mixture for use as thermal insulation material and the amount of silica can at the same time be reduced without the thermal conductivity of the mixture being increased by a factor of more than 2.5, preferably more than 2, more preferably more than 1.5 and in particular more than 1.2, compared to the silica mixture without silicon-containing ashes. The addition of silicon in the form of cheap silicon-containing ashes replaces part of the silica. According to the invention, the mixture contains more than 50% by weight of silicon-containing ashes, preferably more than 60% by weight, more preferably more than 65% by weight and in particular more than 70% by weight.

Even when more than 60% by weight or more than 70% by weight of silicon-containing ash is used in the mixture of the invention, the latter has the advantage that it displays values for the thermal conductivity which are significantly lower than when exclusively silicon-containing ash is used in the mixture (compare, for example, example 1 with example 5 and example 8 with example 6).

It was completely unexpected that the thermal insulation effect of a mixture of silica and silicon-containing ash such as rice hull ash or waste silica is significantly lower at lower proportions of the raw material silica despite the high thermal conductivity of the silicon-containing ashes in pure form.

Owing to this surprising result, it is possible to use a high proportion of silicon-containing ashes combined with a reduced proportion of the raw material silica in the mixture and use this for, for example, thermal insulation without the thermal insulation properties being significantly impaired. The costs can be reduced significantly in this way.

The thermal conductivity A characterizes the specific thermal insulation properties of a material. The smaller the value, the better the thermal insulation effect. The thermal conductivity has the unit watt per meter Kelvin (W/mK). It is temperature-dependent. Its reciprocal is the specific thermal resistance. The values of the thermal conductivity for various materials vary by many orders of magnitude. High values are sought for cooling bodies. On the other hand, an insulation material is a material having a low thermal conductivity which is used for thermal insulation.

The thermal conductivity of a sample as a function of the measurement temperature can be determined, for example, by means of a heat flow measuring instrument in accordance with DIN EN 12939, DIN EN 13163 and DIN EN 12667 at a temperature of from 10° C. to 40° C. Preference is given to using a heat flow meter (HFM) from Netzsch (Selb), more preferably the Lambda meter HFM 436 from Netzsch. The thermal conductivity of the sample is preferably measured at a temperature of 10° C.

For the purposes of the invention, the term “silica” refers to chemically prepared oxides of silicon. Silica is commercially available as raw material. The term silica accordingly encompasses precipitated silica and pyrogenic silica. The salts of the silicas, referred to as silicates, are not encompassed. The silica is preferably pyrogenic silica. This encompasses, for example, HDK® silica from Wacker Chemie AG (Burghausen), Cabosil® silica from Cabot and Aerosil® silica from Evonik Industries (Ort).

Silica displays good thermal insulation properties which shows up as a low thermal conductivity (cf. example 4). Although mixtures without silicas based exclusively on silicon-containing ashes generally have a significantly higher value of thermal conductivity (cf. examples 5 and 6), the thermal conductivity of the mixture of the invention containing at least 50% by weight of silicon-containing ash at a measurement temperature of 10° C. is increased only by a factor of less than 2.5, preferably less than 2 and particularly preferably less than 1.5, compared to the mixture in which the amount of silicon-containing ash has been replaced by pure silica (cf. examples 1-3 and 7-8). The addition of chemically prepared silica in the mixture is therefore not completely dispensed with.

The thermal conductivity of the mixture of the invention at a measurement temperature of 10° C. is preferably less than 0.009 W/mK, more preferably less than 0.005 W/mK and in particular less than 0.004 W/mK.

In a preferred embodiment of the invention, the silica in the mixture is pyrogenic silica. This has the advantage, for example in insulation, that it has an increased insulation capability since, owing to the production process, it has a lower moisture content and lower moisture absorption than precipitated silicas. For this reason, the support cores of vacuum insulation panels, for example, are made predominantly of pyrogenic silica.

Pyrogenic silicas generally have a specific surface area (measured by the BET method) of from 30 to 500 m²/g. The amount of pyrogenic silica used, which is preferably in the range from 25 to 49% by weight, depends on this BET surface area. The higher the BET surface area, the lower the amount used in order to achieve a comparable thermal insulation effect. Preference is therefore given to using small amounts of a pyrogenic silica having a high BET surface area, particularly preferably HDK® N20, T30 or T40 (Wacker Chemie) having a specific surface area of above 170 m²/g.

The specific surface area of a silica is preferably determined in accordance with DIN 9277/66132 by BET measurement (method of Brunauer, Emmett and Teller) by means of nitrogen adsorption.

The term “ash” refers to the inorganic constituents which remain after the combustion of organic material, i.e. of living things such as plants or animals or of fossil fuels. The solid inorganic residues represent a mixture of carbonates, sulfates, phosphates, chlorides and silicates of the alkali metals and alkaline earth metals and also iron oxides and the like. These can be admixed with smaller amounts of unburnt organic material. Particular preference is given to the organic material having been burnt completely and the ash consisting exclusively of inorganic constituents.

For the purposes of the invention, silicon-containing ash consists to an extent of more than 70% by weight, preferably more than 80% by weight and more preferably more than 85% by weight, of silicon dioxide; the proportion can be determined by means of chemical analysis, preferably by digestion with hydrofluoric acid, more preferably in a manner analogous to the determination of silicon oxide as is described in US Pharmacopeia USP 36 NF 31. An example of a silicon-containing ash according to the invention which is preferably used is rice hull ash (also referred to as rice husk ash) which is obtained in the combustion of rice hull residues in the production of rice and is at present predominantly disposed of in a landfill, and thus represents a cheap raw material. The silicon-containing ash in the mixture therefore preferably contains rice hull ash, with particular preference being given to the silicon-containing ash in the mixture being exclusively rice hull ash. It consists to an extent of more than 90% by weight of silicon dioxide (cf. www.refra.com/biogenic silica) and can be procured from many rice mills located in the rice-producing countries.

As a result of silicon inclusions in plant stems, straw and whole plant ashes, e.g. ashes of grasses and reeds, have a silicon content of more than 70% by weight and can be used according to the invention.

It is advantageous for the rice hull ash still to contain residues of soot since these at the same time act as IR blockers.

The silicon-containing ash from combustion furnaces formed in the disposal of silicon-containing offgases or residues is, for example, another cheap product which can be used according to the invention. Such ashes include, inter alia, the filter residue from the flue gas purification in silicon production. Such products are usually offered on the market under the name silica fume. The silicon-containing ash according to the invention preferably comprises silica fume.

However, it is also possible to use other ashes as are typically formed in the disposal of silicon-containing wastes. A characteristic of these cheap fillers is that they generally do not have a defined BET surface area and are sometimes contaminated with other elements such as aluminum, iron, etc.

Particular preference is given to the silicon-containing ash of the mixture of the invention consisting of rice hull ash and silica fume. In particular, it is composed of equal parts of rice hull ash and silica fume.

Thermal insulation systems for relatively high use temperatures frequently contain additional constituents such as hardeners or binders.

A hardener, also referred to as hardening agent, is an addition to synthetically produced adhesives (glues) and surface coatings (reactive surface coating) which initiates or accelerates curing. It consists of acids or salts. In a preferred embodiment of the invention, not more than 1% by weight, more preferably not more than 0.5% by weight and in particular not more than 0.1% by weight, of hardener is added to the mixture according to the invention. In addition, preference is given to no inorganic hardener being added to the mixture; in particular, absolutely no hardener is added. In this way, the costs are reduced and the thermal conductivity of the mixture is kept low since hardeners impair the thermal insulation properties of a mixture. The mixture preferably does not contain any alkali metal silicate solution as is used as hardener in the prior art.

Binders are materials by means of which the solids having a fine degree of division (e.g. powders) are adhesively bonded to one another or to a substrate. Binders are usually added in liquid form to the fillers to be bound and intensively mixed so that they become uniformly distributed and all particles of the filler are wetted uniformly with the binder. Particularly when using liquid binders, these have the disadvantage that the pores of the particles of the mixture are filled on mixing with liquids and the contacts between the particles are increased, as a result of which the thermal conductivity is increased and the insulation is correspondingly impaired. The filler can be given new processing and materials properties by means of the type of binder. In the case of relatively high use temperatures, binders such as polyvinyl alcohol, molasses, sodium hexametaphosphate, Portland cement, sodium silicate, precipitated calcium carbonate may be mentioned.

In a preferred embodiment of the invention, not more than 1% by weight, more preferably not more than 0.5% by weight and in particular not more than 0.1% by weight, of binder is added to the mixture of the invention. In addition, particular preference is given to no slurry based on cellulose, for example paper pulp, being added to the mixture of the invention. More preferably, no organic binder at all, in particular no binder at all, is added to the mixture of the invention. Omission of additives such as binders to the mixture of the invention makes it possible, for example when the mixture is used in thermal insulation, to keep the thermal conductivity low despite the high proportion of by-products and waste products in the form of silicon-containing ashes in the mixture. At the same time, the costs are reduced.

Perlite is a volcanic rock which in terms of its chemical composition corresponds to a natural glass. The perlite rock contains bound water which vaporizes on rapid heating and leads to popcorn-like structures (hollow ceramic spheres). The pumice-like products having thin pore walls which are formed in this way are used, inter alia, as thermal insulation materials in the prior art. It has a thermal conductivity of about 0.04-0.07 W/mK and owing to its structure a low mechanical stability.

The mixture of the invention is characterized in that it does not contain any perlite. As a result, it has the advantage that it contains no fragments of perlite when pressing processes are employed, e.g. in the production of shaped bodies or purely the pressure of the vacuum, for example exerted on the core of a vacuum insulation panel.

The invention further provides for the preferred addition of infrared (IR) opacifiers (also known as IR blockers) to the mixture of the invention. If a material which acts as IR blocker is used as silicon-containing ash, as is usually the case when rice hull ash is used, for example, no further separate IR blocker is added. IR opacifiers are materials which decrease heat radiation by scattering and absorption processes as a result of their composition and structure. Examples of opacifiers are, inter alia, ilmenite, titanium oxide/rutile, silicon carbide, iron(II)/iron(III) mixed oxide, chromium dioxide, zirconium oxide, manganese dioxide, iron oxide, silicon dioxide, aluminum oxide and zirconium silicate, and also mixtures thereof. Preference is given to using carbon blacks and silicon carbide. Preference is given to the opacifiers having an absorption maximum in the infrared range between 1.5 and 10 μm.

In another preferred embodiment of the invention, the mixture of the invention contains fiber material. Here, the amount of fiber material used in the mixture of the invention is preferably not more than 10% by weight and more preferably not more than 5% by weight. A fiber is a flexible structure which is thin relative to the length. Examples of fiber materials are, in addition to the many fibers based on organic polymers such as cellulose, polyethylene or polypropylene, glass wool, rock wool, basalt wool, slag wool and fibers as are obtained from melts (for example by blowing, centrifugation or drawing) and contain aluminum oxide and/or silicon dioxide, for example fused silica fibers, ceramic fibers of a soluble or insoluble type, fibers having an SiO₂ content of at least 96% by weight and glass fibers such as E glass fibers and R glass fibers, and also mixtures of one or more of the types of fibers mentioned. Preference is given to using cellulose fibers, fused silica fibers, ceramic fibers or glass fibers. They typically have a diameter of 0.1-15 μm and a length of 1-25 mm.

The invention further provides a process for producing thermal insulation material, characterized in that the above-described mixture is produced and this mixture is introduced into an envelope, with no sintering occurring in the process and the insulation material not containing any perlite.

The mixture of the invention is firstly produced by intimately mixing silica, preferably pyrogenic silica, with silicon-containing ash, preferably rice hull ash or silica fume, fiber material, preferably cellulose fibers, and optionally IR opacifiers, preferably silicon carbide, with one another. To produce the preferably pulverulent mixture, preference is given to using a commercial mixing device or mixing apparatus, for example the Dispermat VL60 (from Getzmann, Reichshof). It is possible to use, for example, mixing apparatuses having mechanical mixing elements having a low and/or high speed of rotation. However, the individual components can also be mixed by introduction of gas streams such as air streams.

In a further embodiment of the invention, the mixture of the invention is introduced into an envelope.

For this purpose, preference is given to the mixture of the invention firstly being enveloped by a first dust-tight envelope and then being introduced according to the invention into an envelope. The advantage of the use of a first envelope is that it prevents dusts from escaping from the mixture in subsequent process steps and, for example, coating the seams of the second envelope (vacuum film) to be welded and thus preventing airtight welding. It will therefore be described in the following as a dust-tight envelope. As an envelope, it is possible to use a commercial, air-permeable nonwoven or film bag.

The unenveloped, enveloped or dust-tightly enveloped mixture is then preferably introduced into a gastight envelope. Gastight means that this envelope is impermeable to air. It will therefore also be referred to as airtight film. The advantage of a gastight envelope is that it makes it possible to apply a vacuum, so that the thermal conductivity of the mixture is lower.

No sintering step is carried out in the process for producing the thermal insulation material. For the purposes of the present invention, the term sintering refers to a process for producing or changing materials, in which finely particulate, ceramic or metallic materials are heated, usually with an increase in pressure, at temperatures below the intrinsic melting points.

This process is employed mainly in the ceramic industry but also in metallurgy, with granular or pulverulent materials being mixed and bonded to one another by means of heat treatment. After the powder compositions have been brought to the shape of the desired workpiece, either by pressing of the powder compositions or by shaping and drying, as occurs in the production of clay-based ware, the green body is densified and hardened by means of heat treatment below the melting point.

Sintering makes it possible to fuse starting materials which otherwise could be joined to a new material only with great difficulty, if at all. It functions in three steps: densification of the green body occurs first, a substantial minimization of the porosity takes place during the course of the second step and, finally, the desired strength of the materials is reached.

It is advantageous that a time-consuming and costly process step is dispensed with as a result.

In addition, a higher density of the thermal insulation material is brought about by the sintering process, which in turn leads to higher thermal conductivities. Thus, experiments carried out by us have shown that, even without addition of silicon-containing ashes, the thermal conductivity of 0.003 W/mK increases to values of 0.009 W/mK merely as a result of sintering at a temperature of about 900° C.

In contrast, although drying also represents a heat treatment, no chemical reaction occurs during drying since only moisture taken up from the surrounding air is removed.

The process of the invention comprises a drying step but no sintering step.

In a further preferred embodiment of the invention, a shaped body is produced from this mixture. The shaped body is preferably an insulation mat or insulation board.

As is known from, for example, U.S. Pat. No. 5,950,450 or DE 43 39 435, the thermal conductivity of insulation material can be drastically reduced when a vacuum is present in the system. It is therefore possible to introduce the mixture into an envelope such as a nonwoven bag and to weld the shaped body formed into a nonporous envelope such as a composite film in a vacuum-tight manner. Evacuation results in compaction of the material. Owing to their pore structure, silicas still have sufficient mechanical strength even at a reduced vacuum of less than 10 mbar without the envelope having injurious edges.

The use of the mixture for producing a vacuum insulation panel (VIP) is therefore particularly preferred. The support cores of the VIPs consist of microporous powders in the form of silica, silicon-containing ash, fibers and/or IR blockers. Precipitated silicas have a higher moisture content because of the production process. This reduces the insulation capability of the total VIP. For this reason, the support cores are predominantly made of pyrogenic silica.

The production of VIPs is preferably carried out in a plurality of steps:

Firstly, the pulverulent mixture of the invention is produced as described above.

The mixtures obtained are subsequently introduced into an air-permeable envelope and the latter is closed. For example, the introduction can be carried out manually (e.g. by means of a shovel) into a polypropylene film and the latter can be closed by means of hot welding tongs.

The filled nonwoven bags are preferably dried. This can be carried out in a drying oven at temperatures of more than 40° C. The maximum drying temperature depends on the thermal stability of the envelope and is preferably selected 10° C. below the melting point of the envelope.

The filled envelope is subsequently introduced into an airtight film, a vacuum is applied and the film is welded. Gastight and vacuum-tight multilayer films can be used as film. Such films are commercially available and are offered for sale by, for example, the companies Hanita Europe (Rüsselsheim) or Dow Wolff Cellulosics GmbH (Walsrode). Closure can be effected by means of a commercial vacuum welding machine. The vacuum applied is <10 mbar, preferably 0.1 mbar.

As an alternative, shaped bodies can firstly be produced from the mixtures in a pressing process and these can be introduced either into the dust-tight envelope or directly into the nonporous envelope and welded under vacuum.

The mixture of the invention is preferably used for thermal insulation. It is particularly advantageous here that it has an inexpensive composition and can also be produced simply and inexpensively and has low thermal conductivity values. The thermal conductivity is kept low by the omission of binders or hardeners in the mixture.

The mixture of the invention is preferably used as thermal insulation at an intended temperature of up to 95° C., particularly preferably up to 80° C. and in particular up to 70° C. This temperature makes the thermal insulation of buildings, for example, possible but rules out the high-temperature insulation of, for example, ovens, metal baths or hotplates.

### EXAMPLES

### Example 1

A pulverulent mixture of pyrogenic silica HDK® N20 (Wacker Chemie AG, Burghausen), rice hull ash (produced by burning the residues obtained during polishing of rice grains from Patum Rice Mill and Granary, P-mphur Mueng, Thailand) and cellulose fibers (Schwarzwalder Textilwerke, Schenkenzell, chopped short 6 mm) was produced by means of a mixing apparatus from Getzmann (Dispermat VL 60). At a total amount of 800 g, the proportions were as follows:

30% by weight of HDK® N20
65% by weight of rice hull ash
5% by weight of cellulose fibers

The mixture obtained was processed to produce a vacuum insulation panel by firstly being introduced into a nonwoven bag (polypropylene, weight per unit area 27 g/m², Kreykamp GmbH, Nettetal) and this being closed by means of hot welding tongs HZ (230 V, 540 W, Kopp, Reichenbach). Drying was subsequently carried out at 55° C. for 10 hours in a Kelvitron drying oven (Heraeus, Hanau). The filled and dried nonwoven bag was then introduced into an airtight film (Hanita, Rüsselsheim) and welded shut under vacuum at 0.1 mbar by means of an A300 vacuum welding machine (Multivac, Wolfertschwenden).

The thermal conductivity measured at 10° C. in the heat flow measuring instrument (HFM, Netzsch, Selb) in accordance with the manufacturer's instructions is shown in table 1.

### Example 2

The following mixture was used for producing a VIP as described in detail in example 1:

30% by weight of HDK® N20
60% by weight of silica fume
5% by weight of silicon carbide
5% by weight of cellulose fibers

The result of the thermal conductivity measurement at 10° C. is once again shown in table 1.

### Example 3

The following mixture was used for producing a VIP as described in detail in example 1:

25% by weight of HDK® N20
35% by weight of rice hull ash
35% by weight of silica fume
5% by weight of cellulose fibers

The result of the thermal conductivity measurement at 10° C. is shown in table 1.

### Example 4

The following mixture was used for producing a VIP as described in detail in example 1:

85% by weight of HDK® N20
5% by weight of cellulose fibers
10% by weight of silicon carbide

The result of the thermal conductivity measurement at 10° C. is shown in table 1.

### Example 5

The following mixture was used for producing a VIP as described in detail in example 1:

95% by weight of rice hull ash
5% by weight of cellulose fibers

The result of the thermal conductivity measurement at 10° C. is shown in table 1.

### Example 6

The following mixture was used for producing a VIP as described in detail in example 1:

85% by weight of silica fume
5% by weight of cellulose fibers
10% by weight of silicon carbide

The result of the thermal conductivity measurement at 10° C. is shown in table 1.

### Example 7

The following mixture was used for producing a VIP as described in detail in example 1:

23.7% by weight of HDK® N20
71.3% by weight of rice hull ash
5% by weight of cellulose fibers

The result of the thermal conductivity measurement at 10° C. is shown in table 1.

### Example 8

The following mixture was used for producing a VIP as described in detail in example 1:

21.3% by weight of HDK® N20
63.7% by weight of silica fume
5% by weight of cellulose fibers
10% by weight of silicon carbide

The result of the thermal conductivity measurement at 10° C. is shown in table 1.

TABLE 1

| | 1 | 2 | 3 | 4 | 5 |
|---|---|---|---|---|---|
| HDK ®N20 | 30% | 30% | 25% | 85% | — |
| Rice hull ash | 65% | — | 35% | — | 95% |
| Silica fume | — | 60% | 35% | — | — |
| Cellulose | 5% | 5% | 5% | 5% | 5% |
| fibers | | | | | |
| Silicon | — | 5% | — | 10% | — |
| carbide | | | | | |
| λ [W/mK] | 5.9 · 10⁻³ | 5.2 · 10⁻³ | 5.6 · 10⁻³ | 3.6 · 10⁻³ | 30 · 10⁻³ |

| | 6 | 7 | 8 |
|---|---|---|---|
| HDK ®N20 | — | 23.7 | 21.3 |
| Rice hull ash | — | 71.3 | — |
| Silica fume | 85% | — | 63.7 |
| Cellulose fibers | 5% | 5% | 5% |
| Silicon carbide | 10% | — | 10% |
| λ [W/mK] | 9.4 · 10⁻³ | 11.3 · 10⁻³ | 5.4 · 10⁻³ |

λ = Thermal conductivity at 10° C. in W/mK (watt per meter and kelvin)
All percentages are by weight.
The SiO₂ content of the rice hull ash was 91% by weight in all experiments.

### Example 9

The following mixture was used for producing a VIP as described in detail in example 1:

42.5% by weight of HDK® N20
42.5% by weight of hollow glass spheres S25 (3M, St. Paul, USA)
5% by weight of cellulose fibers
10% by weight of silicon carbide

The result of the thermal conductivity measurement at 10° C. is shown in table 2.

### Example 10

The following mixture was used for producing a VIP as described in detail in example 1:

85% by weight of hollow glass spheres S25 (3M, St. Paul, USA)
5% by weight of cellulose fibers
10% by weight of silicon carbide

The result of the thermal conductivity measurement at 10° C. is shown in table 2.

TABLE 2

| | 9 | 10 |
|---|---|---|
| HDK ®N20 | 42.5% | — |
| Hollow glass spheres | 42.5% | 85% |
| Cellulose fibers | 5% | 5% |
| Silicon carbide | 10% | 10% |
| λ [W/mK] | 7.0 · 10⁻³ | 1.1 · 10⁻² |

λ = Thermal conductivity at 10° C. in W/mK (watt per meter and kelvin)
All percentages are by weight.

1.-12. (canceled)

13. A mixture comprising pyrogenic silica and more than 50% by weight of at least one silicon-containing ash, wherein the mixture is free of perlite.

14. The mixture of claim 13, wherein the mixture comprises more than 60% by weight of silicon-containing ash.

15. The mixture of claim 13, wherein the silicon-containing ash consists of rice hull ash.

16. The mixture of claim 14, wherein the silicon-containing ash consists of rice hull ash.

17. The mixture of claim 13, wherein the silicon-containing ash contains silica fume.

18. The mixture of claim 14, wherein the silicon-containing ash contains silica fume.

19. The mixture of claim 15, wherein the silicon-containing ash contains silica fume.

20. The mixture of claim 13, wherein the silicon-containing ash consists of rice hull ash and silica fume.

21. The mixture of claim 14, wherein the silicon-containing ash consists of rice hull ash and silica fume.

22. The mixture of claim 13, wherein at least one IR opacifier is present.

23. The mixture of claim 14, wherein at least one IR opacifier is present.

24. The mixture of claim 15, wherein at least one IR opacifier is present.

25. The mixture of claim 19, wherein at least one IR opacifier is present.

26. The mixture of claim 13, wherein at least one fiber material is present.

27. The mixture of claim 26, wherein at least one fiber material comprises cellulosic fibers.

28. A process for producing thermal insulation material, comprising producing a mixture of claim 13 and introducing this mixture into an envelope, with no sintering occurring in the process and the insulation material not containing any perlite.

29. The process of claim 28, wherein the insulation material is processed to produce a shaped body.

30. The process of claim 29, wherein the shaped body is an insulation mat, an insulation board or a vacuum insulation panel.

31. A thermal insulation material, comprising a mixture of claim 13.

32. A building insulation material comprising a mixture of claim 13.
